(19) United States
(12) Patent Application Publication
(10) Pub. No.: US 2025/0226441 A1
(43) Pub. Date: Jul. 10, 2025

(54) NEW METHOD FOR THE PREPARATION OF A LI-P-S PRODUCT AND CORRESPONDING PRODUCTS

(71) Applicants: SPECIALTY OPERATIONS FRANCE, Lyon (FR); LE CENTRE NATIONAL DE LA RECHERCHE SCIENTIFIQUE, Paris Cedex 16 (FR); UNIVERSITE DE PICARDIE JULES VERNE, Amiens Cedex 1 (FR)

(72) Inventors: Marc-David Braida, Bry-sur-Marne (FR); Ömer Kudu, Amiens (FR); Christian Masquelier, Boves (FR); Thierry Le Mercier, Rosny-sous-Bois (FR); Benoit Fleutot, Boucherville (CA)

(73) Assignees: SPECIALTY OPERATIONS FRANCE, Lyon (FR); LE CENTRE NATIONAL DE LA RECHERCHE SCIENTIFIQUE, Paris Cedex 16 (FR); UNIVERSITE DE PICARDIE JULES VERNE, Paris Cedex 1 (FR)

(21) Appl. No.: 19/093,179

(22) Filed: Mar. 27, 2025

Related U.S. Application Data
(62) Division of application No. 17/630,541, filed on Jan. 27, 2022, now Pat. No. 12,288,843.

(30) Foreign Application Priority Data
Sep. 6, 2019 (EP) 19306075.3

(51) Int. Cl. H01M 10/0562; C01B 25/14; H01B 1/10

(52) U.S. Cl. CPC H01M 10/0562; C01B 25/14; H01B 1/10; C01P 2002/72; C01P 2002/77; C01P 2002/82; C01P 2006/40; H01M 2300/0068

(57) ABSTRACT

The present invention concerns a new method for the preparation of a Li-P-S product, as well as the products obtainable by said methods, and uses thereof especially as solid electrolytes.

The present invention concerns a new method for the preparation of a Li-P-S product, as well as the products obtainable by said methods, and uses thereof especially as solid electrolytes.

### PRIOR ART

Lithium batteries are used to power portable electronics and electric vehicles owing to their high energy and power density. Conventional lithium batteries make use of a liquid electrolyte that is composed of a lithium salt dissolved in an organic solvent. The aforementioned system arises security questions as the organic solvents are flammable. Lithium dendrites forming and passing through the liquid electrolyte medium can cause short circuit and produce heat, which result in accident that leads to serious injuries.

Non-flammable inorganic solid electrolytes offer a solution to the security problem. Furthermore, their mechanic stability helps suppressing lithium dendrite formation, preventing self-discharge and heating problems, and prolonging the life-time of a battery.

Solid sulfide electrolytes are advantageous for lithium battery applications due to their high ionic conductivities and mechanical properties. These electrolytes can be pelletized and attached to electrode materials by cold pressing, which eliminates the necessity of a high temperature assembly step. Elimination of the high temperature sintering step removes one of the challenges against using lithium metal anodes in lithium batteries.

There is thus a need for new solid sulfide electrolytes.

Li₇P₃S₁₁ is a Li-P-S product which possesses a very high Li+ conductivity (1.4×10⁻³ S cm⁻¹ at 25° C. after cold pressing) (Y. Seino, T. Ota, K. Takada, A. Hayashi, M. Tatsumisago, A sulphide lithium super ion conductor is superior to liquid ion conductors for use in rechargeable batteries, Energy Environ. Sci. 7 (2014) 627-631). However, until today, this product is prepared through processes that require the use of Li₂S and P₂S₅ as reagents, which are not chemically stable in ambient atmosphere.

### INVENTION

The aim of the present invention is to provide a new solid electrolyte, comprising in particular Li₇P₃S₁₁.

Another aim of the present invention is to provide a new process for the preparation of a Li-P-S product such as Li₇P₃S₁₁, without requiring the exclusive use of Li₂S and P₂S₅ as reagents.

Another aim of the present invention is to provide a new process for the preparation of a Li-P-S product such as Li₇P₃S₁₁, without requiring working in a protected atmosphere for the whole process.

Therefore, the present invention relates to a method of preparing a Li-P-S product, the method comprising at least the following steps:
(a) mixing at least Li₄P₂S₆, Li₂S and sulfur to obtain a first mixture;
(b) heating the first mixture in an inert atmosphere, under vacuum or under H₂S flow, for a period of time and at a temperature sufficient to produce the Li-P-S product; and
(c) cooling and optionally powdering the Li-P-S product.

Such process is a new synthesis pathway for the synthesis of an important solid sulfide electrolyte, in particular metastable glass-ceramic Li₇P₃S₁₁, which possesses a very high Li+ conductivity (1.4×10⁻³ S cm⁻¹ at 25° C. after cold pressing as mentioned above).

Contrarily to the existing reaction pathways that require the use of only Li₂S and P₂S₅ as reagents, which are not chemically stable in ambient atmosphere, this process uses an Li-P-S compound (i.e. Li₄P₂S₆) as a reagent for synthesis of another Li-P-S compound (i.e. abovementioned Li₇P₃S₁₁). The main advantage of this specific reaction is that it promotes the possibility of using Li₄P₂S₆ as the storage material in a dry room prior to the synthesis of Li₇P₃S₁₁, whereas the conventional reagents Li₂S and P₂S₅ are needed to be stored in a protected atmosphere such as Ar or N.

### DEFINITIONS

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

### DETAILED INVENTION

The method of the invention thus leads to a Li-P-S product, that is to say a product comprising lithium (Li), phosphorus (P) and sulfur(S).

According to an embodiment, the Li-P-S product is chosen in the group consisting of: Li₇P₃S₁₁, Li₃PS₄, Li₇PS₆ and/or Li_{9.6}P₃S₁₂.

More preferably, the Li-P-S product is Li₇P₃S₁₁.

As mentioned above, step (a) of the process according to the invention consists in the preparation of a first mixture from Li₄P₂S₆, Li₂S and sulfur.

Such step is carried out by implementing usual means well-known from the skilled person.

Preferably, step (a) consists in a chemo-mechanical or mechanochemical reaction.

Then, according to step (b), said mixture is heated in an inert atmosphere, under vacuum or under H₂S flow, for a period of time and at a temperature sufficient to produce the Li-P-S product.

As mentioned above, step (b) may be carried out in an inert atmosphere or under vacuum. Step (b) may also comprise an additional sulfur source when this step is carried out under H₂S flow.

Such heating step is carried out by implementing usual means well-known from the skilled person, for example using a sealed quartz tube, a batch furnace or a rotary furnace able to work under argon, nitrogen or H₂S flow.

According to an embodiment, the temperature in step (b) is comprised from 150° C. to 600° C., preferably from 180° C. to 220° C.

According to an embodiment, the heating in step (b) is made over a period of time comprised from 1 hour to 200 hours, for example from 6 hours to 200 hours.

Step (c) consists in cooling the product obtained after step (b). Preferably, this product is cooled down until it reaches the room temperature. Such cooling step is carried out by implementing usual means well-known from the skilled person, such as for instance by letting the furnace going down at room temperature at a rate of 5° C./min.

In particular, this cooling is carried out under natural cooling for a time sufficient to obtain a cooled product having a temperature of about the room temperature. Within the present invention, the room temperature is defined as being of about 25° C.±2° C.

The method of the invention may also comprise a further step of powdering. Such step is carried out after the cooling step. Such powdering step is carried out by implementing usual means well-known from the skilled person, such as for instance, by crushing the sample in a mortar, or applying a low energy deagglomeration step.

Then, after step (c), the Li-P-S is recovered by any means well-known for the skilled person, such as for instance, sieving the powder.

According to an embodiment, Li₄P₂S₆ added in step (a) is obtained from the reaction between Li₂S and P₂S₅. Such reaction is well described in prior art and well-known from the skilled person, such as for instance high temperature solid state reaction as described in (Solid State lonics, 178 (2007), pp. 837-841).

The present invention also relates to the Li-P-S product obtainable by the method as defined above.

As mentioned above, the Li-P-S product is chosen in the group consisting of: Li₇P₃S₁₁, Li₃PS₄, Li₇PS₆ and/or Li_{9.6}P₃S₁₂. Preferably, the present invention thus relates to Li₇P₃S₁₁ obtainable by the method as defined above.

The implementation of the method of the invention gives a specific product of formula Li₇P₃S₁₁ having a crystal structure other than the crystal structure of the Li₇P₃S₁₁ obtained by the prior art methods.

So, the present invention also relates to a product of formula Li₇P₃S₁₁ having a crystal structure and a volume V per formula unit at room temperature comprised between 407 and 412 angstrom cube, as measured by X-Ray Diffraction.

The X-ray Diffraction (XRD) measurements were performed for example using Bragg-Brentano geometry with Cu K-alpha radiation within a D8 Bruker Diffractometer. The preferred measurement conditions were of 15 second per 0.03 degrees step.

The volume V per formula unit is determined using the cell (lattice) parameters acquired at standard atmosphere (101325 Pa) on powder samples.

The volume V per formula unit is the lattice volume V′ divided by the number of formula units Z in a cell, and Z is equal to 2 (Solid State lonics, 178 (2007), pp. 1163-1167).

As well known, V′ is derived from cell (lattice) parameters (a, b, c, α, β, γ).

V′=a.b.c.sqrt(1+2cosα·cosβ·cosγ−cos²α−cos²β−cos²γ)

(a, b and c being (in Ångstroms (Å)) the lengths of sides (edges) and α, β and γ being the angles (°) between them)

According to an embodiment, the product of formula Li₇P₃S₁₁ according to the invention may also comprise an amorphous phase.

Preferably, the product of formula Li₇P₃S₁₁ according to the invention is a product wherein lattice (cell) parameters of the crystal structure, as measured by X-Ray Diffraction, are as follows:
a=12.40 Å according to the profile fitting
b=6.04 Å according to the profile fitting
c=12.52 Å according to the profile fitting

According to an embodiment, the product of formula Li₇P₃S₁₁ according to the invention is a product wherein lattice (cell) parameters of the crystal structure, as measured by X-Ray Diffraction, are as follows:
alpha=103.30° according to the profile fitting
beta=113.25° according to the profile fitting
gamma=75.07° according to the profile fitting

The present invention also relates to the use of the product as defined above, alone or in combination with any crystalline or amorphous conductive Li-material, as solid electrolyte.

Preferably, the present invention relates to the use of the product of formula Li₇P₃S₁₁ as defined above, in particular having a crystal structure and a volume V per formula unit at room temperature comprised between 407 and 412 angstrom cube, as measured by X-Ray Diffraction, alone, as solid electrolyte.

According to an embodiment, said product may be used in combination with any crystalline or amorphous conductive Li-material, such as for instance beta-Li₃PS₄ or glassy Li₃PS₄.

The present invention also relates to a solid electrolyte comprising at least one product as defined above.

Preferably, the solid electrolyte according to the invention comprises a product of formula Li₇P₃S₁₁ as defined above, in particular having a crystal structure and a volume V per formula unit at room temperature comprised between 407 and 412 angstrom cube, as measured by X-Ray Diffraction.

The present invention also relates to a battery, preferably a lithium battery comprising at least the Li-P-S product obtainable by the method of the invention or a product of formula Li₇P₃S₁₁ having a crystal structure and a volume V per formula unit at room temperature comprised between 407 and 412 angstrom cube, as measured by X-Ray Diffraction.

The battery where the product of the invention is used can be a lithium-ion or a lithium metal battery.

The battery is composed of a positive and a negative electrode with electroactive substances able to reversibly intercalate and de-intercalate lithium ions.

In the case of forming a positive electrode, the active substance may be selected from the group consisting of a composite metal chalcogenide represented by a general formula of LiMY₂, wherein M denotes at least one species of transition metals such as Co, Ni, Fe, Mn, Cr, Al and V; and Y denotes a chalcogen, such as O or S. Among these, it is preferred to use a lithium-based composite metal oxide represented by a general formula of LiMO₂, wherein M is the same as above. Preferred examples thereof may include: LiCoO₂, LiNiO₂, LiNiₓCo₁₋ₓO₂ (0<x<1), Lix(Ni_{0.8}Co_{0.15}Al_{0.05})O₂, Li(Ni_{1/3}Co_{1/3}Mn_{1/3})O₂, Li(Ni_{0.6}Co_{0.2}Mn_{0.2})O₂, Li(Ni_{0.8}Co_{0.1}Mn_{0.1})O₂ and spinel-structured LiMn₂O₄ and LiMn_{1.5}Ni_{0.5}O₄. These active materials may be coated with inorganic or organic coatings, such as LiNbO₃.

As an alternative, still in the case of forming a positive electrode, the active substance may comprise a lithiated or partially lithiated transition metal oxyanion-based electrode materials of the nominal formula AB(XO₄)_{f}E_{1-f}, in which A is lithium, which may be partially substituted by another alkali metal representing less that 20% of the A metals, B is a main redox transition metal at the oxidation level of +2 chosen among Fe, Mn, Ni or mixtures thereof, which may be partially substituted by one or more additional metal at oxidation levels between +1 and +5 and representing less than 35% of the main +2 redox metals, including 0, XO₄ is any oxyanion in which X is either P, S, V, Si, Nb, Mo or a combination thereof, E is a fluoride, hydroxide or chloride anion, f is the molar fraction of XO₄ oxyanion, generally comprised between 0.75 and 1.

The active substance for use in forming a positive electrode can also be sulfur or Li₂S.

In the case of forming a negative electrode, the active substance may preferably comprise a carbon-based material and/or a silicon-based material and/or lithium metal

In some embodiments, the carbon-based material may be, for example, graphite, such as natural or artificial graphite, graphene, or carbon black.

These materials may be used alone or as a mixture of two or more thereof.

The carbon-based material is preferably graphite.

The silicon-based compound may be one or more selected from the group consisting of silicon, silicon carbide and silicon oxide.

The lithium metal may be used as a lithium foil or as lithium powder.

### FIGURES

FIG. 1: Comparison of the XRD patterns of the simulated pattern of Li₄P₂S₆ [1], the synthesized Li₄P₂S₆ (Example 1), and the ball-milled product of the Reaction 1 (Example 2).

FIG. 2: Comparison of the Raman spectra of the synthesized Li₄P₂S₆ (Example 1), the ball-milled product of the Reaction 1 (Example 2), the crystalline Li₇P₃S₁₁ that is formed by annealing Example 2 (Example 3), and the crystalline Li₇P₃S₁₁ that was synthesized from the conventional reagents Li₂S and P₂S₅.

FIG. 3: Comparison of the XRD patterns of the crystalline Li₇P₃S₁₁ that is synthesized via the Reaction 1 (Example 3), the crystalline Li₇P₃S₁₁ that was synthesized from the conventional reagents Li₂S and P₂S₅, and the simulated pattern of Li₇P₃S₁₁ [11].

FIG. 4: Comparison of the XRD patterns of the crystalline Li₇P₃S₁₁ that is synthesized via the Reaction 1 (Example 3), and the empty Be-equipped sample holder.

FIG. 5: Results of the profile fitting of Examples 4 and 3. The Bragg positions were indicated with black vertical lines, the fits were plotted with a solid black line, and the collected data were shown in black hollow spheres. The regions marked with asterisk were omitted from the fit as they involve the contribution of the sample holder as shown in FIG. 4.

FIG. 6: Deconvolution of the signals coming from the structural moieties PS₄³⁻, P₂S₇⁴⁻ and P₂S₆⁴⁻ in the Raman spectrum of Example 3. The relative ratios of the peak areas are also noted on the top left of the figure.

FIG. 7: Deconvolution of the signals coming from the structural moieties PS₄³⁻, P₂S₇⁴⁻ and P₂S₆⁴⁻ in the Raman spectrum of Example 4. The relative ratios of the peak areas are also noted on the top left of the figure.

FIG. 8: Comparison of the ionic conductivity values versus inverse temperature (1/T) of the ball-milled product of the Reaction 1 (Example 2), the crystalline Li₇P₃S₁₁ that is synthesized via the Reaction 1 (Example 3), the crystalline Li₇P₃S₁₁ that was synthesized from the conventional reagents Li₂S and P₂S₅.

FIG. 9: Comparison of the σ×T values versus inverse temperature (1/T) of the ball-milled product of the Reaction 1 (Example 2), the crystalline Li₇P₃S₁₁ that is synthesized via the Reaction 1 (Example 3), the crystalline Li₇P₃S₁₁ that was synthesized from the conventional reagents Li₂S and P₂S₅. The linear fits to calculate the slope of the lines were also shown as solid black lines.

### EXAMPLES

The disclosure will now be illustrated with working examples, which is intended to illustrate the working of disclosure and not intended to take restrictively to imply any limitations on the scope of the present disclosure. Other examples are also possible which are within the scope of the present disclosure.

### Example 1

Li₂S and P₂S₅ (both produced by Sigma Aldrich) were used as starting materials. 1.5 g of total powder at a molar ratio of 2:1 were put in a 45 mL ZrO₂ jar with 12 ZrO₂ balls (3 g/ball, 10 mm diameter) in an Ar filled glovebox. The jar was sealed with scotch and parafilm to prevent air exposure, then was taken out of the glovebox and was placed in Fritzch Planetary Micro Mill Pulverisette 7. It was ball-milled with 510 RPM rotating speed for 38 hours while employing 15 minute breaks in every 15 minutes of milling, in order to prevent excessive heating of the jar. The jar was then moved to an Ar filled glovebox to recover the powder. Then, the resulting white powder was pelletized at 530 MPa with a 6 mm diameter die. The pellet was vacuum sealed in a carbon coated quartz tube, then the tube was heated to 350° C. with 5° C./min heating rate, and was kept at the same temperature for 36 hours. After the annealing step, the tube was slowly cooled down to RT, and it was opened in an Ar filled glovebox.

### Example 2

400 mg of Example 1, 46 mg of sulfur, and 22 mg of Li₂S (produced by Sigma Aldrich) were mixed in an Ar filled glovebox to balance the reaction below:

3Li₄P₂S₆+3S+Li₂S=2Li₇P₃S₁₁ Reaction 1:

The mixture was put in a 45 mL ZrO₂ jar with 8 ZrO₂ balls (3 g/ball, 10 mm diameter). The jar was sealed with scotch and parafilm to prevent air exposure, then was taken out of the glovebox and was placed in Retsch PM200 Planetary Ball-milling Apparatus. It was ball-milled with 510 RPM rotating speed for 76 hours while employing 15 minute breaks in every 15 minutes of milling, in order to prevent excessive heating of the jar. The jar was then moved to an Ar filled glovebox to recover the powder.

### Example 3

Example 2 was pelletized at 530 MPa with a 6 mm diameter die. The pellet was vacuum sealed in a carbon coated quartz tube, then the tube was annealed at 200° C. for 84 hours. After the annealing step, the tube was slowly cooled down to RT, and it was opened in an Ar filled glovebox to recover the sample.

### Example 4 (Comparative)

Li₂S and P₂S₅ (both produced by Sigma Aldrich) were used as starting materials. 1.5 g of total powder at a molar ratio of 7:3 were put in a 45 mL ZrO₂ jar with 12 ZrO₂ balls (3 g/ball, 10 mm diameter) in an Ar filled glovebox. The jar was sealed with scotch and parafilm to prevent air exposure, then was taken out of the glovebox and was placed in Fritzch Planetary Micro Mill Pulverisette 7. It was ball-milled with 510 RPM rotating speed for 76 hours while employing 15 minute breaks in every 5 minutes of milling, in order to prevent excessive heating of the jar. The jar was then moved in an Ar filled glovebox to collect the powder. The resulting white powder was pelletized at 530 MPa with a 10 mm diameter die. The pellet vacuum sealed in a carbon coated quartz tube, then the tube was annealed at 200° C. for 168 hours. After the annealing step, the tube was slowly cooled down to RT, and it was opened in an Ar filled glovebox.

### Characterization Tools

X-ray diffraction of the samples were collected using a Bruker D8 diffractometer with Cu Kα radiation at RT. The samples were sealed in a Be-equipped sample holder in an Ar filled glovebox prior to the experiment. The diffractions were collected in 2θ range of 10° to 100° in 13 hours. The lattice parameters were determined by fitting the diffraction profiles using Full-Prof Suite. Profile fitting procedures of Example 3 and Example 4 were limited in a shorter 2θ range (10° to) 28° to increase the accuracy of the fit because the high number of Bragg positions in P-1 space group at higher angles could mislead the fitting process. The small peaks which are attributed to the Be-equipped sample holder (see FIG. 4) were removed before the fitting process to increase the precision of the fitting.

The Raman spectra were collected using a Raman DXR Microscope (Thermo Fischer Scientific) with excitation laser beam wavelength of 532 nm and a low laser power of 0.1 mW to prevent excessive heating of the sample. The fitting processes were performed using Omnic Software of Thermo Fischer Scientific.

Before the impedance spectroscopy measurements, powder samples were cold-pressed in an Ar filled glovebox. Example 2 and Example 3 were pressed with a 6 mm diameter die with 530 MPa pressure, while Example 4 was pressed with a 10 mm diameter die with 530 MPa pressure. The pellets were then sandwiched between pre-dried carbon paper electrodes, and then loaded into air-tight sample holders. The AC impedance spectra were collected by using Biologic MTZ-35 frequency response analyser. During the measurements, the AC potential for excitation was set at 50 mV for all the samples. The frequency range of the measurement of Example 2 was 0.05 Hz to 30 MHz, whereas a range of 1 Hz to 30 MHz was applied in the measurements of Example 3 and Example 4. The spectrum of each sample was recorded at stabilized temperature values varying between −30° C. and 50° C. in steps of 10° C. The ionic conductivity values were obtained by fitting the data into equivalent circuit models using ZView software. The slopes of the σT versus 1/T plots were used to determine activation energy values.

### Experimental Results

3Li₄P₂S₆+3S+Li₂S=2Li₇P₃S₁₁ Reaction 1:

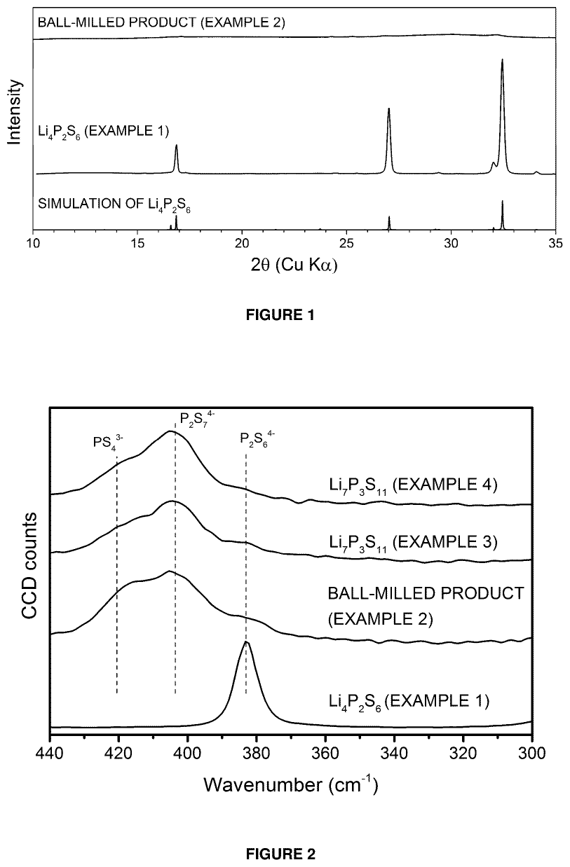

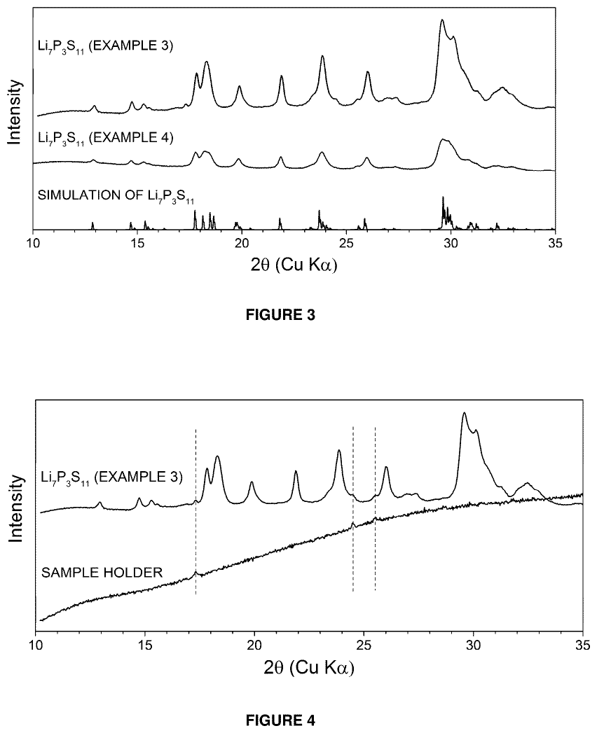

The Bragg peaks observed in the XRD pattern of Example 1 show correlation to the simulated peak positions of crystalline Li₄P₂S₆ [1], as shown in FIG. 1. In the Raman spectrum of Example 1 in FIG. 3, the only peak centered at 383 cm^{-1 1}is due to the vibration of P—S bond in P₂S₆⁴⁻ anion [2,3]. Hence, the sample was considered phase pure and was used as a precursor in the Reaction 1.

The Reaction 1 was performed via mechanochemical synthesis route, and the reaction product was named as Example 2. As shown in FIG. 1, the product was X-ray amorphous, which indicated that the reagents were successfully amorphized. It is known in the literature that when Li₂S (<75 at %) and P₂S₅ are used as reagents for the mechanochemical synthesis of Li-P-S compounds, the reaction leads to the formation of X-ray amorphous products, similar to the case of Example 2 [4-10]. Until today, a Li-P-S compound (i.e. Li₇P₃S₁₁) has never been synthesized using a different Li-P-S compound (i.e. Li₄P₂S₆) as precursor [6-10].

After the mechanochemical reaction, the vibrations of P-S bonds in P₂S₇⁴⁻ and PS₄³⁻ moieties appear in the Raman spectrum of Example 2, see FIG. 2. It is inferred from the drastic decrease in the intensity of the signal of P₂S₆⁴⁻ unit that some of the phosphorus ions in the P₂S₆⁴⁻ moieties were oxidized from +4 to +5 during the mechanochemical reaction. It is known that P₂S₇⁴⁻ unit can be reacted to form P₂S₆⁴⁻ unit by reducing the phosphorus at 280-300° C. [5,7]. It was shown for the first time with the Reaction 1 that the process could be reversed by a mechanochemical reaction.

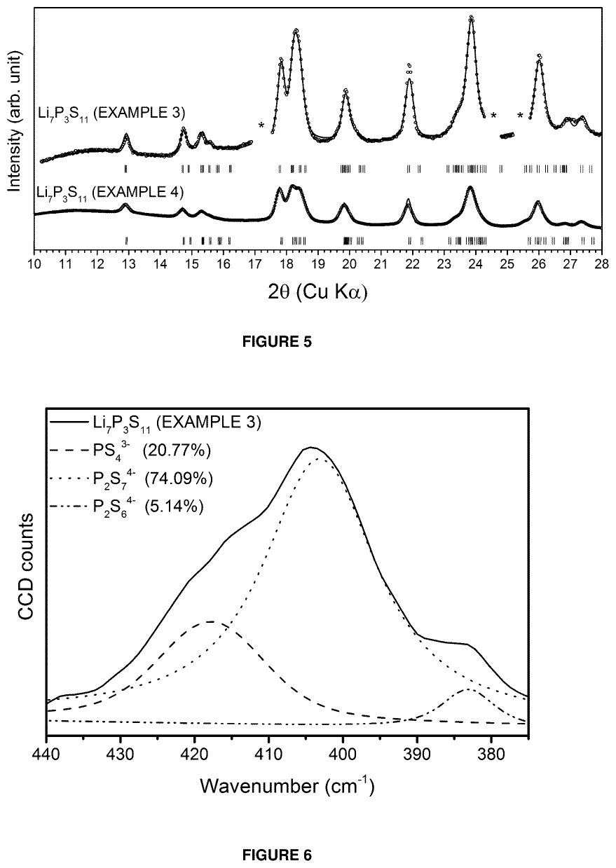

The XRD pattern of Example 3 showed correlation to the simulated pattern of crystalline Li₇P₃S₁₁ [11], as evidenced by XRD in FIG. 3. Additional peaks with small intensity were also observed at 17.3°, 24.5° and 25.5°, which originate from the Be-equipped sample holder, with which the pattern of the powder was collected. The comparison of the pattern of Example 3 and the Be-equipped sample holder is presented in FIG. 4. The XRD pattern of Example 4, which was synthesized using Li₂S and P₂S₅ as precursors was also shown in FIG. 3 for comparison. Several differences between Examples 3 and 4 were noted. Sharper peaks were present in the pattern of Example 3, which indicates higher crystallinity compared to Example 4. The lattice parameters of Examples 3 and 4 were obtained by profile fitting. The resulting fit and the Bragg positions were shown in FIG. 5. In the figure, the hollow circles indicate the collected data, and the black line indicates the resulting profile fit. Significant differences were observed in the profile parameters of Examples 3 and 4, and the reference from the literature [11], see Table 1. The unit cell of Example 3 has a drastically shorter lattice parameter a, and larger alpha and gamma angles compared to Example 4 and the material reported in the literature. Beta angle of Example 3 was observed to be larger than the literature example, but it was comparatively smaller than the one of Example 4. These results proved that the crystalline Li₇P₃S₁₁ obtained by the Reaction 1 was structurally different than the materials synthesized by starting from the conventional reagents Li₂S and P₂S₅.

TABLE 1
Lattice parameters, in triclinic P-1 description, for Examples 3
and 4 versus lattice parameters reported in the literature [11]

| | a (Å) | b (Å) | c (Å) | alpha (°) | beta (°) | gamma (°) | V (Å³) |
|---|---|---|---|---|---|---|---|
| Example 3 | 12.40 | 6.04 | 12.52 | 103.30 | 113.25 | 75.07 | 823 |
| Example 4 | 12.46 | 6.05 | 12.53 | 103.14 | 113.33 | 74.70 | 828 |
| Reference | 12.50 | 6.03 | 12.53 | 102.85 | 113.20 | 74.47 | 829 |
| [11] | | | | | | | |

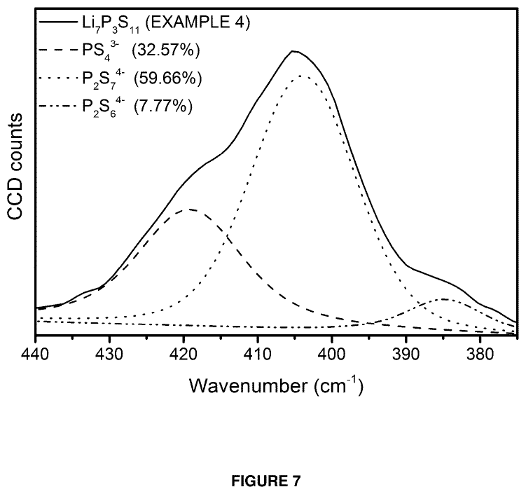

The Raman spectra of Examples 3 and 4 show the presence of bond vibrations of PS₄³⁻, P₂S₇⁴⁻ and P₂S₆⁴⁻ moieties at 421 cm⁻¹, 404 cm⁻¹ and 383 cm⁻¹, respectively, see FIG. 2. These results show correlation to the results published in the literature [7,8,10,12-15]. In order to make a semi-quantitative comparison of the quantities of the moieties in Examples 3 and 4, the spectra were fitted into three peaks centered at the reported positions of structural moieties [5]. The relative ratios of the peak areas were also compared. As shown in FIGS. 6 and 7, Examples 3 and 4 manifested drastic differences in their local structures.

Relative ratio of PS₄³⁻/P₂S₇⁴⁻ in Example 3 was calculated to be 0.28, whereas the ratio in Example 4 deviated significantly and was noted down as 0.55. It was also observed that the relative intensity of peak of P₂S₆⁴⁻ units was 2.63% lower in the case of Example 3. These results clearly indicated that the material which was synthesized from the reagents Li₂S and P₂S₅ possessed different structural properties than the material synthesized from a different Li-P-S compound as in the case of the Reaction 1.

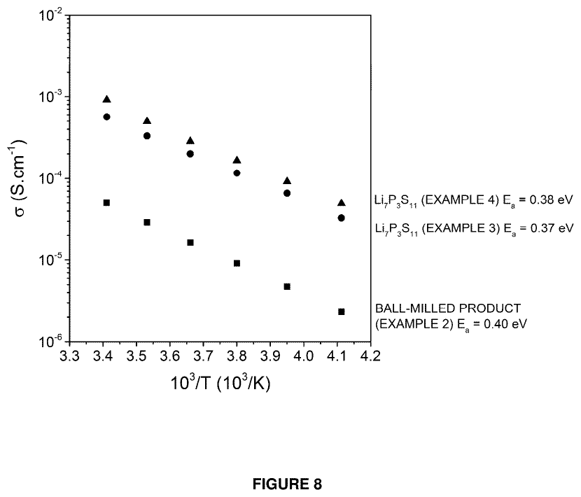

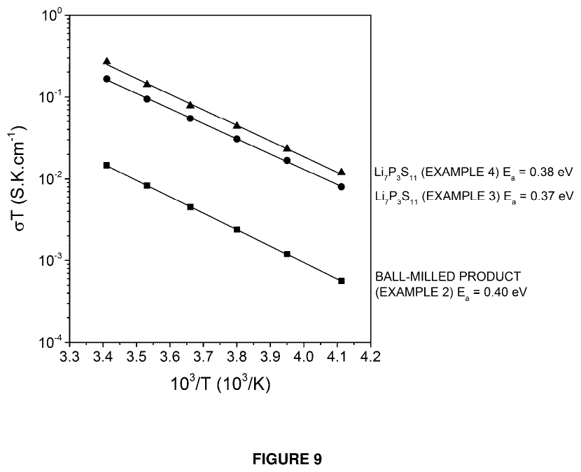

The ionic conductivities of Examples 2, 3 and 4 were shown as a function of temperature (−30° C. to 20° C.) in FIG. 8. The activation energies were calculated from the σT vs 1/T plots using Equation 1, and the linear fits of the data to calculate the slope were also shown in FIG. 9:

$$σ * T = {σ}_{0} * {e}^{- \frac{Ea}{kT}} \qquad Equation 1$$

Example 2 demonstrated 5×10⁻⁵ Scm⁻¹ conductivity at 20° C. with an activation energy of 0.40 eV. After the crystallization of Li₇P₃S₁₁ via subsequent annealing of Example 2, Example 3 showed a significant increase in the conductivity by 6×10⁻⁴ S·cm⁻¹ at 20° C. The activation energy for the conduction was also decreased to 0.37 eV, which is smaller than that of Example 4 (0.38 eV), which was synthesized from the precursors Li₂S and P₂S₅. Example 4 possessed a slightly higher ionic conductivity of 9×10⁻⁴ Scm⁻¹ at 20° C. These results also show correlation to the values reported in the literature [6, 14-18].

The results obtained from different characterization tools indicate that crystalline Li₇P₃S₁₁ can be synthesized by using an alternative synthesis route as described in the Reaction 1.

The resulting product (Example 3) according to the invention showed significant difference in terms of lattice parameters compared to the values reported in the literature, and the ones of the crystalline Li₇P ₃S₁₁ that was synthesized by using Li₂S and P₂S₅ as reagents (Example 4—comparative). Additionally, the relative ratios of the structural moieties in Examples 3 and 4 were calculated to be drastically different. It was also shown by the impedance spectra that the ionic conductivities of both examples and the materials reported in the literature are quite similar. It was also noted that a successful reaction from one member of the Li₂S—P₂S₅ binary system to the other member has been reported for the first time in the literature. This discovery paves the way to finding other alternative reaction pathways between different members of the binary system.

### REFERENCES

[1] S. Neuberger, S.P. Culver, H. Eckert, W.G. Zeier, J. Schmedt auf der Günne, Refinement of the crystal structure of Li4P2S6 using NMR crystallography, Dalt. Trans. (2018). doi:10.1039/C8DT02619J.
[2] C. Dietrich, M. Sadowski, S. Sicolo, D.A. Weber, S.J. Sedlmaier, K.S. Weldert, S. Indris, K. Albe, J. Janek, W.G. Zeier, Local Structural Investigations, Defect Formation, and lonic Conductivity of the Lithium Ionic Conductor Li4P2S6, Chem. Mater. 28 (2016) 8764-8773. doi:10.1021/acs.chemmater.6b04175.
[3] M. Tachez, J. Malugani, R. Mercier, R. Guy, Ionic conductivity of and phase transition in Li thiophosphate Li3PS4, Solid State Ionics. 14 (1984) 181-185. doi:http://dx.doi.org/10.1016/0167-2738(84)90097-3.
[4] M. Tatsumisago, S. Hama, A. Hayashi, H. Morimoto, T. Minami, New lithium ion conducting glass-ceramics prepared from mechanochemical Li2S-P2S5 glasses, Solid State lonics. 154 (2002) 635-640. doi:10.1016/S0167-2738(02)00509-X.
[5] C. Dietrich, D.A. Weber, S.J. Sedlmaier, S. Indris, S.P. Culver, D. Walter, J. Janek, W.G. Zeier, Lithium ion conductivity in Li2S-P2S5 glasses—building units and local structure evolution during the crystallization of superionic conductors Li3PS4, Li7P3S11 and Li4P2S7, J. Mater. Chem. A. 5 (2017) 18111-18119. doi: 10.1039/C7TA06067J.
[6] Y. Seino, T. Ota, K. Takada, A. Hayashi, M. Tatsumisago, A sulphide lithium super ion conductor is superior to liquid ion conductors for use in rechargeable batteries, Energy Environ. Sci. 7 (2014) 627-631. doi:10.1039/C3EE41655K.
[7] Y. Seino, M. Nakagawa, M. Senga, H. Higuchi, K. Takada, T. Sasaki, Analysis of the structure and degree of crystallisation of 70Li2S-30P2S5 glass ceramic, J. Mater. Chem. A. 3 (2015) 2756-2761. doi:10.1039/C4TA04332D.
[8] Y. Aoki, K. Ogawa, T. Nakagawa, Y. Hasegawa, Y. Sakiyama, T. Kojima, M. Tabuchi, Chemical and structural changes of 70Li2S-30P2S5 solid electrolyte during heat treatment, Solid State lonics. 310 (2017) 50-55. doi:10.1016/j.ssi.2017.08.006.
[9] K. Minami, A. Hayashi, M. Tatsumisago, Crystallization Process for Superionic Li7P3S11 Glass-Ceramic Electrolytes, J. Am. Ceram. Soc. 94 (2011) 1779-1783. doi:10.1111/j.1551-2916.2010.04335.x.
[10] M.R. Busche, D.A. Weber, Y. Schneider, C. Dietrich, S. Wenzel, T. Leichtweiss, D. Schröder, W. Zhang, H. Weigand, D. Walter, S.J. Sedlmaier, D. Houtarde, L.F. Nazar, J. Janek, In Situ Monitoring of Fast Li-lon Conductor Li7P3S11 Crystallization Inside a Hot-Press Setup, Chem. Mater. 28 (2016) 6152-6165. doi:10.1021/acs.chemmater.6b02163.
[11] H. Yamane, M. Shibata, Y. Shimane, T. Junke, Y. Seino, S. Adams, K. Minami, A. Hayashi, M. Tatsumisago, Crystal structure of a superionic conductor, Li7P3S11, Solid State lonics. 178 (2007) 1163-1167. doi:10.1016/j.ssi.2007.05.020.
[12] R.C. Xu, X.H. Xia, Z.J. Yao, X.L. Wang, C.D. Gu, J.P. Tu, Preparation of Li7P3S11 glass-ceramic electrolyte by dissolution-evaporation method for all-solid-state lithium ion batteries, Electrochim. Acta. 219 (2016) 235-240. doi:10.1016/j.electacta.2016.09.155.
[13] M. Calpa, N.C. Rosero Navarro, A. Miura, K. Tadanaga, Preparation of sulfide solid electrolytes in the Li2S—P2S5 system by a liquid phase process, Inorg. Chem. Front. (2017). doi:10.1039/C7QI00737J.
[14] Y. Wang, D. Lu, M. Bowden, P.Z. El Khoury, K.S. Han, Z.D. Deng, J. Xiao, J.-G. Zhang, J. Liu, Formation mechanism of Li7P3S11 solid electrolytes through liquid phase synthesis, Chem. Mater. (2018) acs.chemmater.7b04842. doi:10.1021/acs.chemmater.7b04842.
[15] M. Calpa, N.C. Rosero Navarro, A. Miura, K. Tadanaga, Preparation of sulfide solid electrolytes in the Li2S—P2S5 system by a liquid phase process, Inorg. Chem. Front. (2018) 501-508. doi:10.1039/C7QI00737J.
[16] I.H. Chu, H. Nguyen, S. Hy, Y.C. Lin, Z. Wang, Z. Xu, Z. Deng, Y.S. Meng, S.P. Ong, Insights into the Performance Limits of the Li7P3S11 Superionic Conductor: A Combined First-Principles and Experimental Study, ACS Appl. Mater. Interfaces. 8 (2016) 7843-7853. doi:10.1021/acsami.6b00833.
[17] S. Wenzel, D.A. Weber, T. Leichtweiss, M.R. Busche, J. Sann, J. Janek, Interphase formation and degradation of charge transfer kinetics between a lithium metal anode and highly crystalline Li7P3S11 solid electrolyte, Solid State lonics. 286 (2016) 24-33. doi:10.1016/j.ssi.2015.11.034.
[18] S. Ito, M. Nakakita, Y. Aihara, T. Uehara, N. Machida, A synthesis of crystalline Li7P3S11 solid electrolyte from 1,2-dimethoxyethane solvent, J. Power Sources. 271 (2014) 342-345. doi:10.1016/j.jpowsour.2014.08.024.

1-16. (canceled)

17. A product of formula Li₇P₃S₁₁, comprising a crystal structure and a volume V per formula unit at room temperature, using the cell parameters acquired at standard atmosphere, comprised between 407 and 412 angstrom cube, as measured by X-Ray Diffraction, using a Bruker D8 diffractometer with Cu Kα radiation.

18. A method of using the product of 17, the method comprising using the product, alone or in combination with any crystalline or amorphous conductive Li-material, as solid electrolyte.

19. A solid electrolyte comprising at least the product of claim 17.

20. A battery comprising at least the product of claim 17.

21. The product of claim 17, having lattice parameters a=12.40 Å, b=6.04 Å and c=12.52 Å, as measured by X-Ray Diffraction, using a Bruker D8 diffractometer with Cu Ka radiation.

22. The method of claim 18, wherein the crystalline conductive Li-material is beta-Li₃PS₄ and amorphous conductive Li-material is glassy Li₃PS₄.

23. The solid electrolyte of claim 19, further comprising any crystalline or amorphous conductive Li-material.

24. The battery of claim 20, composed of a positive and a negative electrode with electroactive substances able to reversibly intercalate and de-intercalate lithium ions.

25. The battery of claim 24, wherein the positive electrode is formed with an electroactive substance selected from the group consisting of a composite metal chalcogenide represented by a general formula of LiMY₂, wherein M denotes at least one species of transition metals such as Co, Ni, Fe, Mn, Cr, Al and V; and Y denotes a chalcogen.

26. The battery of claim 24, wherein the positive electrode is formed with electroactive substance and comprises a lithiated or partially lithiated transition metal oxyanion-based electrode material of the nominal formula:
AB(XO₄)_{f}E_{1-f},
wherein
A is lithium, which may be partially substituted by another alkali metal representing less that 20% of the A metals,
B is a main redox transition metal at the oxidation level of +2 chosen among Fe, Mn, Ni or mixtures thereof, which may be partially substituted by one or more additional metal at oxidation levels between +1 and +5 and representing less than 35% of the main +2 redox metals, including 0,
XO₄ is any oxyanion in which X is either P, S, V, Si, Nb, Mo or a combination thereof,
E is a fluoride, hydroxide or chloride anion, and
f is the molar fraction of XO₄ oxyanion, generally comprised between 0.75 and 1.

27. The battery of claims 25, wherein the chalcogen Y is O or S.
